(19) United States
(12) Patent Application Publication
(10) Pub. No.: US 2014/0122983 A1
(43) Pub. Date: May 1, 2014

(54) METHOD AND APPARATUS FOR PROVIDING ATTRIBUTION TO THE CREATORS OF THE COMPONENTS IN A COMPOUND MEDIA

(71) Applicant: Nokia Corporation, Espoo (FI)

(72) Inventors: Mate Sujeet Shyamsundar, Tampere (FI); Curcio Igor Danilo Diego, Tampere (FI)

(21) Appl. No.: 13/663,650

(22) Filed: Oct. 30, 2012

(51) Int. Cl. G06F 17/00

(52) U.S. Cl. 715/202

(57) ABSTRACT

An approach is provided for providing attribution to the creators of the components of a compound media. A device based architecture, a peer-to-peer architecture or a client-server architecture determines creator information for components of a compound media item. Then, the device based architecture, a peer-to-peer architecture or a client-server architecture causes, at least in part, a presentation of attribution indicators to associate the creator information with the components of a compound media item. Such presentation is caused substantially concurrently with a presentation of the compound media item.

### BACKGROUND

Service providers and device manufacturers (e.g., wireless, cellular, etc.) are continually challenged to deliver value and convenience to consumers by, for example, providing compelling network services. The development of network services has brought about a culture of user participation wherein creation of compound media from a plurality of user generated content has exploded. Such large scale explosion of compound media has resulted in a need for provisioning a service that attributes the creators of original contents used in a compound media. However, there is currently no framework that provides attribution to the creators of the original content used in the composition of a compound media. Accordingly, service providers and device manufacturers face significant technical challenges in providing attribution to the creators, if a compound media is generated using the originally created media.

### Some Example Embodiments

Therefore, there is a need for an approach for providing due credit to the content creators in a complex compound media types in a user friendly manner.

According to one embodiment, a method comprises determining creator information for one or more components of at least one compound media item. The method also comprises causing, at least in part, a presentation of one or more attribution indicators to associate the creator information with the one or more components at least substantially concurrently with a presentation of the at least one compound media item.

According to another embodiment, an apparatus comprises at least one processor, and at least one memory including computer program code for one or more computer programs, the at least one memory and the computer program code configured to, with the at least one processor, cause, at least in part, the apparatus to determine creator information for one or more components of at least one compound media item. The apparatus also causes, at least in part, a presentation of one or more attribution indicators to associate the creator information with the one or more components at least substantially concurrently with a presentation of the at least one compound media item.

According to another embodiment, a computer-readable storage medium carries one or more sequences of one or more instructions which, when executed by one or more processors, cause, at least in part, an apparatus to determine creator information for one or more components of at least one compound media item. The apparatus also causes at least in part, a presentation of one or more attribution indicators to associate the creator information with the one or more components at least substantially concurrently with a presentation of the at least one compound media item.

According to another embodiment, an apparatus comprises means for determining creator information for one or more components of at least one compound media. The apparatus also comprises means for causing, at least in part, a presentation of one or more attribution indicators to associate the creator information with the one or more components at least substantially concurrently with a presentation of the at least one compound media item.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-31, and 48-50.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing attributions to the creators of the components of a compound media, according to one embodiment;

FIG. 2 is a diagram of the components of the user attribution platform, according to one embodiment;

FIG. 3 is a flowchart of a process for providing attributions to the creators of the components of a compound media, according to one embodiment;

FIG. 4 is a flowchart of a process for determining temporal intervals for the presentation of the one or more attribution indicators;

FIG. 5 is a flowchart of a process for determining component modalities and causing presentation based on such component modalities, according to one embodiment.

FIG. 6 is a flowchart of a process for determining availability information wherein the presentation of the one or more attribute indicators is based;

FIG. 7 is a flowchart of a process for determining other information and causing presentation of the other information, according to one embodiment;

FIG. 8 is a diagram of one or more user interfaces utilized in the process of FIGS. 3-6, according to various embodiments;

FIG. 9 is a diagram of one or more user interfaces utilized in the process of FIGS. 3-6, according to various embodiments;

FIG. 10 is a diagram of one or more user interfaces utilized in the process of FIGS. 3-6, according to various embodiments;

FIG. 11 is a diagram of one or more user interfaces utilized in the process of FIGS. 3-6 according to various embodiments;

FIG. 12 is a diagram of one or more user interfaces utilized in the process of FIGS. 3-6 according to various embodiments;

FIG. 13 is a diagram of hardware that can be used to implement an embodiment of the invention;

FIG. 14 is a diagram of a chip set that can be used to implement an embodiment of the invention; and

FIG. 15 is a diagram of a mobile terminal (e.g., handset) that can be used to implement an embodiment of the invention.

### DESCRIPTION OF SOME EMBODIMENTS

Examples of a method, apparatus, and computer program for providing attributions to the creators of the components of a compound media are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

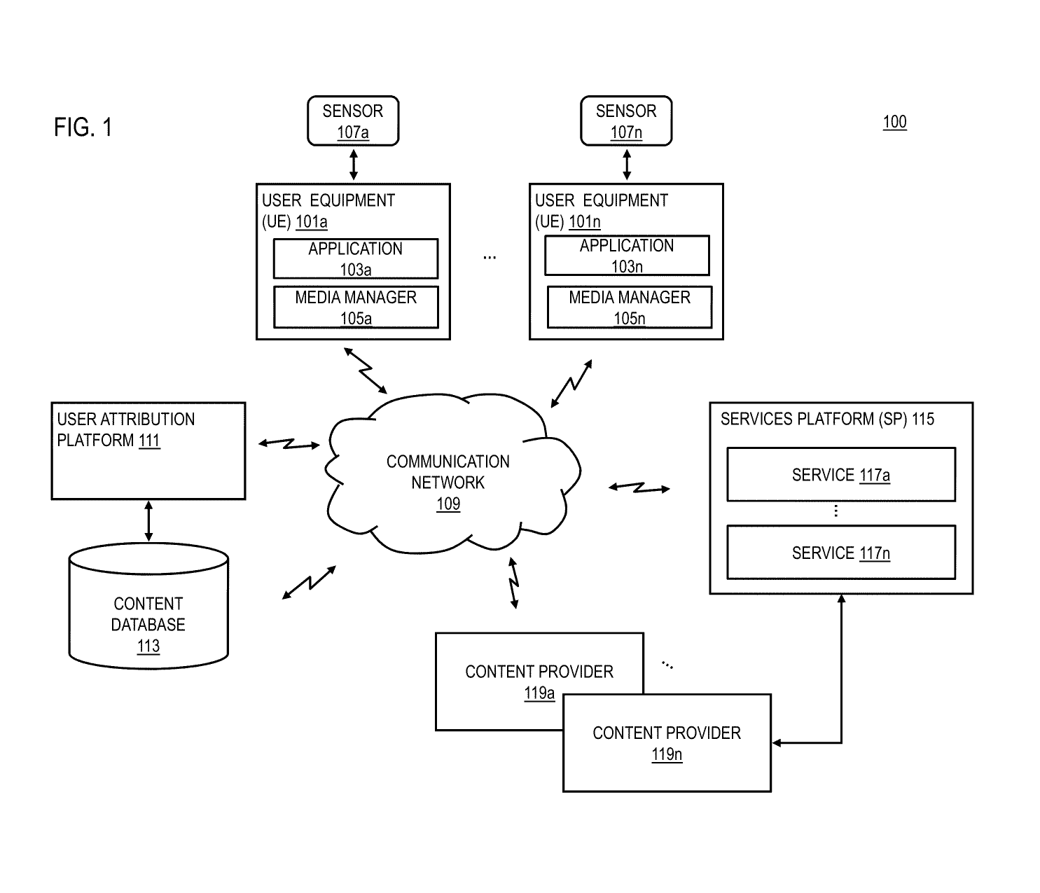

FIG. 1 is a diagram of a system capable of providing attributions to the creators of the components of a compound media, according to one embodiment. As mentioned, service providers and device manufacturers are continually challenged to provide compelling network services, that may include a user attribution platform that enable attribution indicators to associate the creator information with the components used in a compound media. The existing service(s) do not identify the originator; there is a problem of lack of attribution to the creator in any compound media that uses a magnitude of user generated content. In some embodiments, the user attribution platform may also be implemented as a completely mobile device based architecture, as a peer-to-peer architecture or as a client-server architecture.

To address this problem, a system 100 of FIG. 1 introduces the capability to provide a presentation of attribution indicators that associate to creator's information with the components of a compound media. The system 100 provides the ability to enhance user experience by providing due credit to the content creators in a complex compound media. The inventions may allow a compound media to inherit the content creator's acknowledgement, if a compound media is generated using the originally created media. In some embodiments, the inventions may allow a compound media to inherit the content creator's acknowledgement, if a compound media is generated using a compound media and the originally created media.

As shown in FIG. 1, the system 100 comprises user equipment (UE) 101a-101n (collectively referred to as UEs 101) that may include or be associated with applications 103a-103n (collectively referred to as applications 103), media manager 105a-105n ((collectively referred to as media manager 105) and sensors 107a-107n (collectively referred to as sensors 107).

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that may perform various processes and/or functions at the UE 101. For instance, applications 103 may be a client for presenting one or more compound media files. In one embodiment, the client may support presenting one or more video files, one or more audio files, one or more textual files or a combination thereof, such as one or more movies, one or more slideshows, one or more articles, one or more presentations, etc. The client may have standard or default user interface elements that are used during the presentation of media files. However, based on the system 100, the client may be enabled to present and/or include one or more additional user interfaces elements during the presentation of a compound media segment and/or media file based on the inclusion of the multi-view and/or multi-layered user attribution including user interface elements of various modalities. Thus, in a sense, the client may be a thin client that provides functionality associated with presenting a compound media file and/or a media segment that is enhanced by the inclusion of various types of user interface element across various modalities based on the multimodal user attribution generated by the user attribution platform 111.

The media manager 105 may be, for example, a specialized one of the applications 103, one or more hardware and/or software modules of the UE 101, or a combination thereof for rending one or more compound media segments and/or compound media files and one or more associated user interface elements that are appended to the one or more compound media segments and/or compound media files including a multi-view and/or multi-layered user attribution including user interface elements of various modalities. The media manager 105 interfaces with or receives information from the user attribution platform 111 for processing a multimodal track at the UE 101 that the user attribution platform 111 appended to a compound media segment and/or a compound media file. By way of example, an application 103 (e.g., such as a client) requests a compound media file, which is processed by the user attribution platform 111 to include a multi-view and/or multi-layered user attribution including user interface elements of various modalities. The media manager 105 then may process the user interface elements of various modalities received from the user attribution platform 111 and send the processed information to the application 103 (e.g., client) for presentation of the one or more user interface elements included in the compound media over communication network 109.

In addition, the sensors 107 may be any type of sensor. In one embodiment, the sensors 107 may include one or more sensors that are able to determine user published contents associated with UE 101. In one scenario, the sensors 107 may include location sensors (e.g., GPS), motion sensors (e.g., compass, gyroscope), light sensors, moisture sensors, pressure sensors, audio sensors (e.g., microphone), or receivers for different short-range communications (e.g., Bluetooth, WiFi, etc.).

As shown in FIG. 1, the UE 101 have connectivity to other components via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the user attribution platform 111 may be a platform with multiple interconnected components. The user attribution platform 111 may include multiple servers, intelligent networking devices, computing devices, components and corresponding software for performing the function of providing attribution to the creator of a user generated content used in generating a compound media. In addition, it is noted that the user attribution platform 111 may be a separate entity of the system 100, a part of the one or more services 117 of the service platform 115, or included within the UE 101 (e.g., as part of the application 103).

The user attribution platform 111 is a platform that determines and processes creator information for one or more components of at least one compound media item. As described below, the user attribution platform 111 may perform the functions of providing an intermediate service for causing a presentation of attribution indicators to associate the creator information with a component at least substantially concurrently with a presentation of a compound media item.

In one embodiment, the user attribution platform 111 identifies and provides presentation of attribution indicators concurrently with a presentation of the at least one compound media item. The user attribution platform 111 may determine creator information for one or more components of at least one compound media item that is uploaded and may be played by a mobile device upon the occurrence of an event at the mobile device or in some embodiments of the implementation as a default behavior. Upon the occurrence of the event (or as a default behavior), the user attribution platform 111 may determine one or more component modalities based, at least in part, on a viewpoint and/or contextual information associated with at least one viewer for a given time instance. In one scenario, for instance, Steve, John and Jack may be the creators of the videos used in a compound media compiled by Ray. As such, Ray may use UE 101 to create a compound media; upon creation and uploading of the media, the user attribution platform 111 may process the compound media to determine the creator information and generate creator indicators accordingly. If, for instance, any viewer tries to access the compound media, the user attribution platform 111 causes presentation of attribution indicators, wherein Steve, John and Jack are attributed for the contents they created. Such attribution indicators may be presented concurrently with the presentation of the compound media item.

In another embodiment, the user attribution platform 111 may determine temporal intervals for the presentation of the attribution indicators based on the occurrence of the components in the presentation of a compound media item. For instance, Steve, John and Jack may be the creators of the video, audio and lyrics, respectively, used in a compound media compiled by Ray. If, for instance, any viewer tries to access the compound media, the user attribution platform 111 determines temporal intervals for the presentation of the attribution indicator for each component, ensuring that all the user attributions are rendered in a manner that is least distracting to the overall viewing experience of the compound media.

Further, the user attribution platform 111 may cause a presentation of attribution indicators upon determination of component modalities based on viewpoint and/or contextual information. For instance, if any viewer accesses a compound media, the presentation attributing the creators Steve, John and Jack is based on the viewpoint of the viewer, the viewer would see a view of the multiview content and the attribution indicator corresponding to that view. This enables view level user attribution of the component and also implementation embodiment to have multiple contributing users represented on different views of the same temporal segment. Further, the user attribution platform 111 may compute a set of preferred attribution indicators for viewers accessing the compound media. The preferred attribution indicators may be dynamically updated as the user attribution platform 111 receives updates from UE 101. This information may be stored for each viewer within the content database 113 associated with the user attribution platform 111, as illustrated in FIG. 1. Additionally, viewers accessing a compound media may periodically update their information such that the user attribution platform 111 is aware of the status of the viewers associated with UE 101 accessing the compound media. In one embodiment, a service 117 may alternatively update the status of the viewers of the compound media. This information may be stored in the content database 113 associated with the user attribution platform 111, as illustrated in FIG. 1.

The system 100 may also include a services platform 115 that may include one or more services 117a-117n (collectively referred to as services 117). The services 117 may be any type of service that provides any type (or types) of functions and/or processes to one or more elements of the system 100. By way of example, the one or more services 117 may include social networking services, information provisioning services, content provisioning services (e.g., such as movies, videos, audio, images, slideshows, presentations, etc.), and the like. In one embodiment, one of the services 117 (e.g., a service 117) may be an automated video analyzer service. The services 117 may process one or more compound media segments and/or compound media files to analyze, for example, the type, subject, and characteristics associated with the compound media segment and/or compound media files. For example, the services 117 may insert cue points between various segments of a compound media file, may distinguish one or more original files within a compound media file, may determine when a compound media file was created, may determine sensory information (e.g., contextual information) associated with the compound media file, etc. Where the media file is a video or a combination of images such as a slideshow, the services 117 may determine various angles and/or dimensions associated with the images. Thus, the services 117 may process the one or more media segments and/or media files to supply information to the user attribution platform 111 to be able to determine the user interface elements for interacting with the compound media segment and/or compound media file. Further, where the services 117 includes compound media segment and/or compound media file provisioning services, the UE 101 may request specific media from the services 117 for presenting at the UE 101. Further, one or more services 117 may provide one or more media segments and/or media files to the UE 101 without the UE 101 requesting the media segments and/or files. Additionally, although the user attribution platform 111 is illustrated in FIG. 1 as a separate entity, in one embodiment, the functions and/or processes performed by the user attribution platform 111 may be embodied in one or more services 117 at the services platform 115. By way of example, where one or more of the services 117 provide for streaming of one or more compound media segments and/or compound media files, the one or more services 117 also may perform the processing discussed herein associated with the user attribution platform 111 to append user attribution to the compound media segments and/or compound media files.

The system 100 may further include one or more content providers 119a-119n (collectively referred to as content providers 119). The content providers 119 may provide content to the various elements of the system 100. The content may be any type of content or information, such as one or more videos, one or more movies, one or more songs, one or more images, one or more articles, contextual information regarding the UE 101 or a combination thereof, and the like. In one embodiment, a UE 101 may constitute one of the content providers 119, such as when two or more UE 101 is connected in a peer-to-peer scenario. In one embodiment, one or more compound media segments and/or one or more compound media files may be requested by one or more services 117 from the content providers 119 for transmitting to the UE 101. In which case, the user attribution platform 111 may process the compound media segments and/or compound media files prior to transmission to the UE 101 from the content providers 119 by way of the services 117. Further, in one embodiment, the functions and/or processes performed by user attribution platform 111 may be embodied in one or more content providers 119. By way of example, where one or more of the content providers 119 provide content of one or more media segments and/or media files, the one or more content providers 119 may also perform the processing discussed herein associated with the user attribution platform 111 to append a user attribution to the compound media segments and/or compound media files.

Further, although the user attribution platform 111, the services platform 115, and the content providers 119 are illustrated as being separate elements of the system 100 in FIG. 1, in one embodiment, the functions and/or processes performed by the multimodal user attribution platform 111, the services platform 115 (e.g., including the services 117), and the content providers 119 may be embodied in a single element of the system 100. The single element may then store one or more compound media segments and/or compound media files, append user attribution to the one or more compound media segments and/or compound media files, and provide the one or more compound media segments and/or compound media files (e.g., via streaming) to devices (e.g., the UE 101) in the system 100.

The UE 101 may send a request for the compound media segment, or the compound media segment may be sent to the UE 101 based on one or more other devices and/or services 109 requesting the segment for the at least one device. Under either approach, the user attribution platform 111 may receive a request and determine a user attribution including user interface elements associated with the compound media segment. In one embodiment, where the UE 101 requests the compound media segment, the UE 101 may send with the request capability information associated with the device (e.g., a device profile extension (DPE) which may be a dynamic profile of the device or a CC/PP based UAProf (User Agent Profile) information, which may be a static profile of the device), preference information associated with the user of the device (e.g., a personal preference profile or user profile), contextual information associated with the device or a combination thereof. The capability information of the device (e.g., UE 101) may include the current capabilities of the device and/or future capabilities of the device. The user attribution platform 111 processes the capability information, the preference information and/or the contextual information and builds a user interface elements for indicating user attribution from the information. Thus, in one embodiment, the created track is specific to the particular device and/or the particular user of the device. However, the multimodal track may be generic to any number of similar devices and or users based on similar capabilities and/or preferences of the devices and/or users.

In one embodiment, the user attribution platform 111 determines templates based on features and/or characteristics extracted from processing the media segment. The templates may be particular to one or more modalities based on the extracted features and/or characteristics of the compound media segment. Templates may be used that are specific for each modality, or there may be templates that cover multiple modalities. By way of example, with respect to a video modality, the user attribution platform 111 may first fill in a standard template that would be used by a local video recognizer associated with a UE 101. One or more templates that are familiar to a user could be construed as standard video user interface elements available to a client framework for presentation and/or enablement of the compound media segment supporting a video user interface which comprises of user attribution. In one embodiment, the template may be locally resident on the UE 101, or may be stored in one or more content providers 119 or provided by one or more services 117. Where the words and/or tokens are stored locally, the enablement of the user interface elements during presentation of the compound media segment may occur while the UE 101 is offline. However, where the words and/or tokens are stored over a network, the enablement of the user interface elements may allow for the inclusion of more user interface elements (such as more words and/or tokens) that are accessible over the network. The user attribution platform 111 may then receive these templates to include as user interface elements within a compound media.

By way of example, the UE 101, the user attribution platform 111, the services platform 115, the services 117 and the content providers 119 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

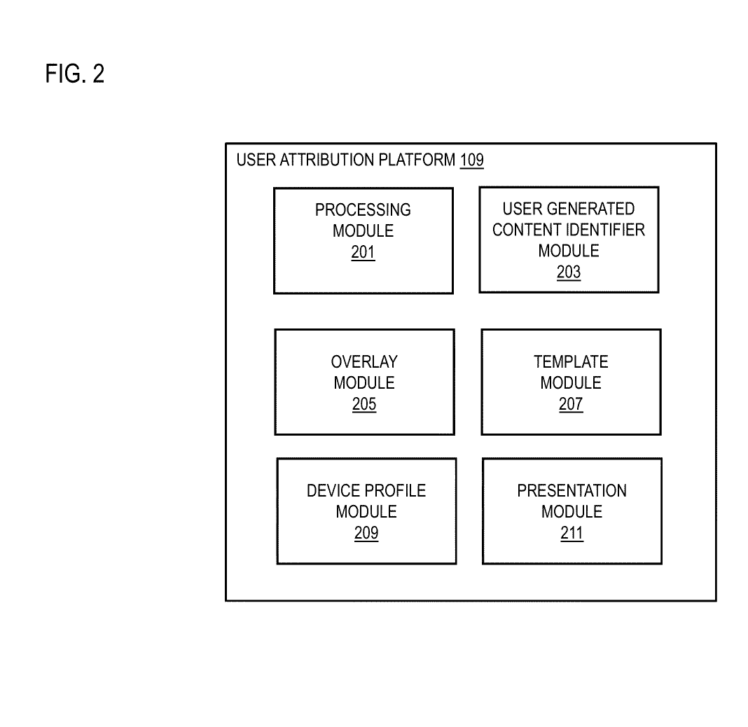

FIG. 2 is a diagram of the components of the user attribution platform 111, according to one embodiment. By way of example, user attribution platform 111 includes one or more components for providing attribution to one or more creator of a user generated content used in generating a compound media. As discussed above, it is contemplated that the functions of these components may be combined in one or more components or performed by other components of equivalent functionality. In this embodiment, the user attribution platform 111 includes a processing module 201, a user generated content identifier module 203, an overlay module 205, a template module 207, a device profile module 209, and a presentation module 211.

The processing module 201 enables the user attribution platform 111 to determine the content information associated with a creator by collecting or determining content information associated with the creator. In one embodiment, the processing module 201 may determine content information from the content database 113, the applications 103 executed at the UE 101, the sensors 105 associated with the UE 101, and/or one or more services 115 on the services platform 113. As the UE 101 sends an attribution request to user attribution platform 111, the processing module 201 provides the user attribution platform 111 with the content information.

In one embodiment, the processing module 201 may track the exchange of content information for particular users registered with the user attribution platform 111 and/or associated with the content information in the content database 113. In this manner, the statistical data that is obtained may be used for any suitable purpose, including the identification of the creator of the content information. The processing module 201 may, for instance, execute various protocols and data sharing techniques for enabling collaborative execution between the UE 101, the user attribution platform 111, services 115, content database 113 over the communication network 107.

The user generated content identifier module 203, executes at least one algorithm for executing functions of the user attribution platform 111. For example, the user generated content identifier module 203 may interact with the processing module 201 to enables the user attribution platform 111 to process the content information of a compound media to determine one or more creator of the content information. Each time a UE 101 sends a request for a compound media, the user generated content identifier module 203 compares the content information and may identify the creators associated with the contents of a compound media. As discussed before, a compound media, is a combination of two or more videos, audios, images, scripts and the like, depending on the type of media. The user generated content identifier module 203 attributes the creator of each fragment of a compound media based on its identification.

The overlay module 205 overlays information of one or more creators of content information used in the composition of a compound media which is then presented to one or more user while they access the compound media. The overlay module 205 receives inputs from the processing module 201 and the user generated content identifier module 203, and then generates a display attributing the creators based on the received input. Such attribution to content creator may be done by embedding the information of the creators at the time of the creation of a compound media. The overlaying of attribution can be registered with the presentation module 209 to cause presentation of the overlay with the compound media. In one embodiment, the service 115 that processes the compound media for determining, for example, the characteristics and/or features of the compound media that are associated with the user interface elements of various modalities may also process the compound media for defining the presentation information. For instance, where the compound media is a video associated with multiple views and/or angles, the overlay module 205 can provide inputs that describe and/or defines the various views and/or angles. This information may then be used by the presentation module 213 for controlling the presentation and/or rendering of the compound media with user attribution.

The template module 207 includes one or more templates that may be particular to one or more modalities of user interface elements. The templates may have various features and/or categories that are filled in, based on, for example, features and/or characteristics of the media segment or media file. By way of example for a video modality, specifically video recognition, the template module 207 may determine a video recognition template for user interface elements and fill in the template based on inputs from the user generated content identifier module 203 and overlay module 205. The template may be modified based on, for example, the device capabilities, the user preferences, and/or the contextual information. The presentation of the template may be familiar to the user and could be construed as standard speech associated with user interface elements available to a client. The presentation template may be resident locally at the device or may be resident on one or more networked devices and/or services 115 and accessible to the device. Other templates associated with other modalities can be generated based on a similar approach that can be used as user interface elements for interacting with a media segment and/or file.

The device profile module 209 may determine the capabilities of the devices that present the compound media that the user attribution platform 111 associates with. The capabilities may be defined based on, for example, one or more device capability files that are transmitted to the user attribution platform 111 or referred to upon a request of a media segment and/or media file. The files may be formatted according to a device profile extension (DPE). The capabilities defined by the file may be static and/or dynamic and can represent the current and/or future capabilities of the device. For example, the capabilities may be based on a current processing load associated with the device such that the user attribution platform 111 can determine whether to include user interface elements of modalities that may require greater than normal/average processing power. The capabilities may also be based on other resources, such as whether the device is currently connected to one or more sensors, etc. The resources may also be specific to certain modalities. For example, the device profile may include the words and/or tokens that the device is compatible with. The device profile module 209 may also include contextual information of the user of the UE 101. The contextual information may then be transmitted to the overlay module 205 and the template module 207 for determining the presentation of user attribution based, at least in part, on the contextual information.

In certain embodiments, the presentation module 211 may cause an enabling of the presentation of a compound media overlaid with user attribution information. The presentation module 213 generates user interface elements for UE 101 associated with one or more compound media. In one embodiment, the presentation module 213 may include separate unimodal logic creation engines for each modality type (e.g., audio, speech, etc.) that may be continuously and/or periodically updated. In one embodiment, the presentation module 213 may include a single multimodal logic creation engine that covers the various modality types. The presentation module 213 uses the user interface element templates from the template module 207, along with inputs from unimodals (if any) compared against the device capabilities, and/or contextual information to determine the user interface elements that are associated to the media segment and/or media file within the multimodal track. The presentation module 213 may associate the user attribution with the compound media based on any particular format or standard format prior to sending the media file and/or media segment to the client on the UE 101.

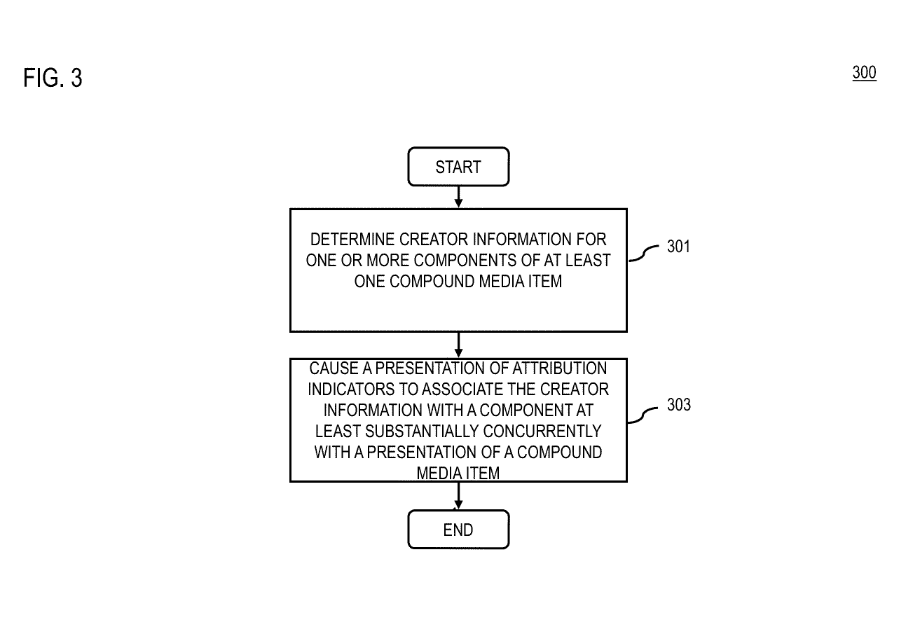

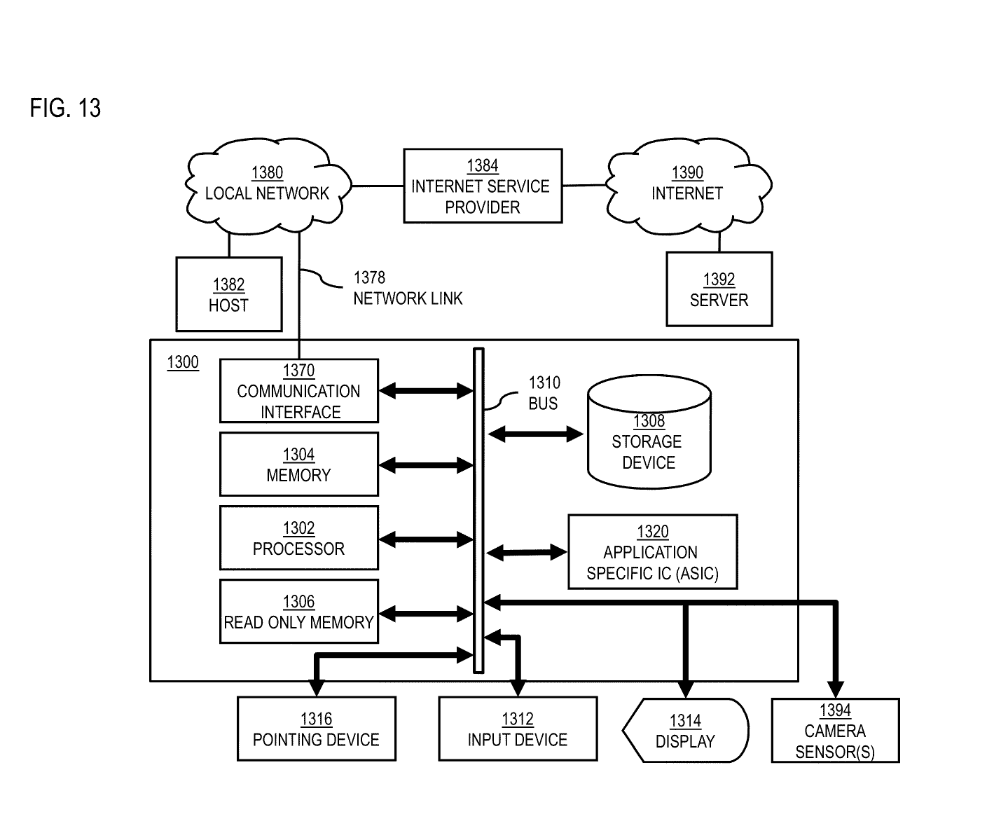

FIG. 3 is a flowchart of a process for providing attributions to the creators of the components of a compound media, according to one embodiment. In one embodiment, the user attribution platform 111 performs the process 300 and is implemented in, for instance, a chip set including a processor and a memory as shown in FIG. 13.

In step 301, a request for attribution to the originator of the components may be sent when a UE 101 composes a compound media from various original components. Such transmission of the request between the UE 101 and the user attribution platform 111 results in user attribution platform 111 processing the content information of the compound media. Each time a UE 101 sends an attribution request, the user generated content identifier module 203 compares the content information and may identify the creators associated with the contents of a compound media. The content of a compound media is processed to determine creator information for one or more components of at least one compound media item.

Thus, the user attribution platform 111 takes into consideration the content information of UE 101. The creator information may be determined from one or more applications 103 executed by the UE 101, one or more media manager 105 executed by the UE 101, one or more sensors 107 associated with the UE 101, one or more services 117 on the services platform 115, and/or content providers 119.

In step 303, the user attribution platform 111 upon determining the creator information causes, at least in part, a presentation of one or more attribution indicators to associate the creator information with the one or more components at least substantially concurrently with a presentation of the at least one compound media item. The attribution indicator includes, at least in part, one or more multi-functional indicators, for example, the attribution indicators may be user interface elements associated with creators name/avatar, it may be associated with a tactile modality where the user touches the indicators to implement the various functionalities, such as, hyperlink to user's social network page, contributor media usage information update, etc.

The one or more functions of the one or more multi-functional indicators include, at least in part, (a) presenting additional information associated with one or more creators of the one or more components; (b) linking to source media associated with the one or more components; (c) providing historical creator information; (d) updating usage information for the one or more components, the at least one compound media item; or (e) a combination thereof. Such presentation of one or more attribution indicators is via (a) one or more overlays on the presentation of the compound media item; (b) one or more secondary display devices; (c) or a combination thereof.

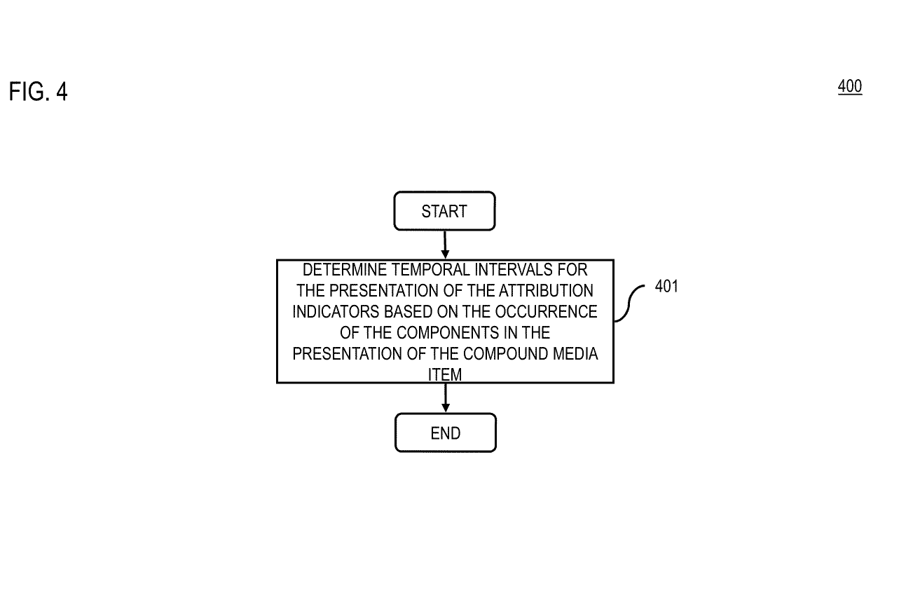

FIG. 4 is a flowchart of a process for providing attributions to the creators of the components of a compound media, according to one embodiment. In one embodiment, the user attribution platform 111 performs the process 400 and is implemented in, for instance, a chip set including a processor and a memory as shown in FIG. 13.

In step 401, the user attribution platform 111 determines one or more temporal intervals for the presentation of the one or more attribution indicators based, at least in part, on the occurrence of the one or more components in the presentation of the at least one compound media item. The user attribution could be for one or more users for a given temporal interval corresponding to plurality of layers and/or plurality of modalities and/or plurality of views for a compound media that may be multi-layered and/or multi-modal and/or multi-view in nature. The visual attribution is done for multiple users that may have contributed to multiple media modalities for a given spatio-temporal segment of time. Thus, the invention does not limit attribution to one user at a time for a given temporal segment. For example, for a given temporal segment an audio track is provided by Steve, video track is provided by John and the sub-titles are provided by Rick, this embodiment will enable all the user attributions to be rendered in a manner that is least distracting to the overall viewing experience of the compound media.

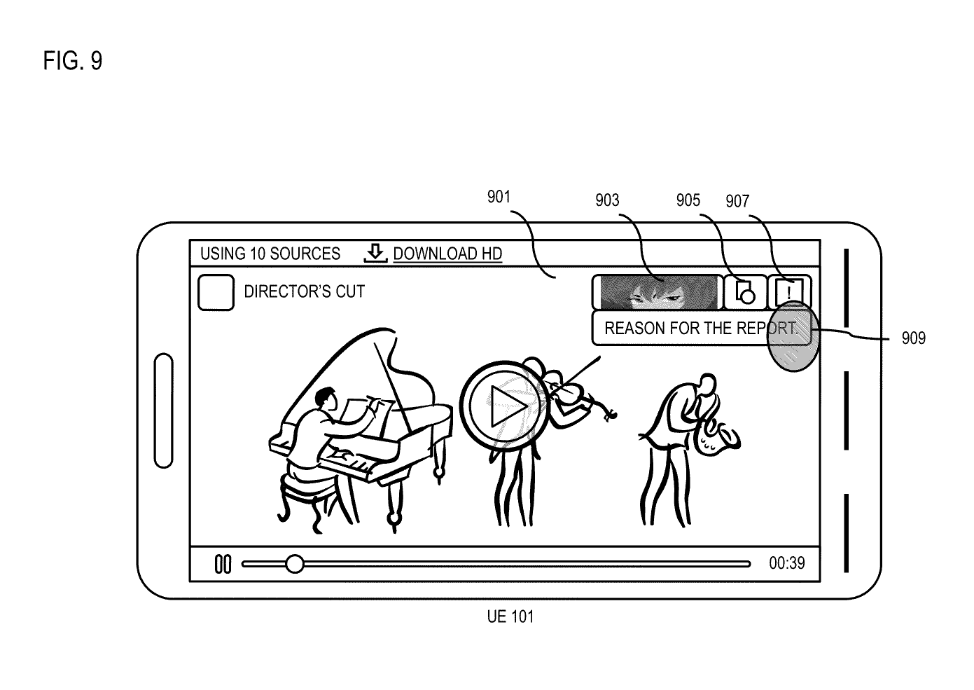

In another embodiment, the user attribution platform 111 determines the usage information of the contributed content in temporal interval as well as the one or more views for the given temporal interval. A given temporal interval can have one or more users' content for one or more views. This implies that a single view at a given temporal instant may be attributed to one or more creators, and multiple views at a given temporal instant may be attributed to a single creator. This process is further represented in FIG. 9.

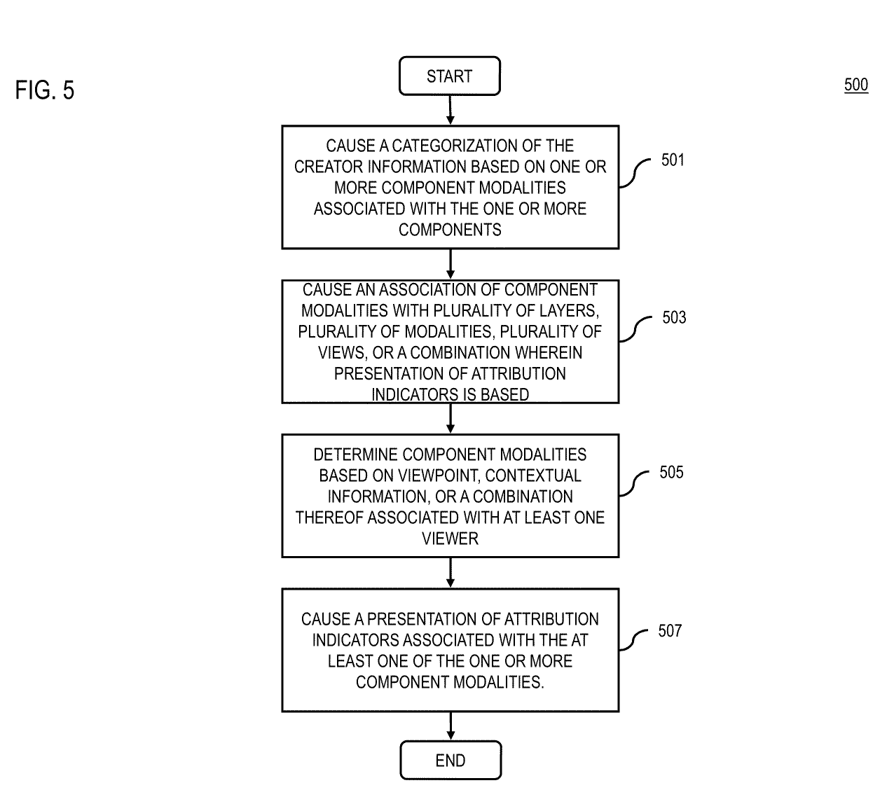

FIG. 5 is a flowchart of a process for providing attributions to the creators of the components of a compound media, according to one embodiment. In one embodiment, the user attribution platform 111 performs the process 500 and is implemented in, for instance, a chip set including a processor and a memory as shown in FIG. 13.

In step 501, the user attribution platform 111 causes, at least in part, a categorization of the creator information based, at least in part, on one or more component modalities associated with the one or more components. The technical implementation of the attribution indicators of content creators when used in a compound media may depend on the modalities of the components of a compound media, for example, implementation characteristics of the component may include different media types such as audio, video, text, image, etc., the user attribution platform 111 may cause categorization of creator information based on such modalities of the component of a compound media.

In step 502, upon categorization of creator information, the user attribution platform 111 causes, at least in part, an association of the one or more component modalities with respective one or more of the plurality of layers, the plurality of modalities, the plurality of views, or a combination thereof, wherein the presentation of the one or more attribution indicators is based, at least in part, on the association.

In step 503, the user attribution platform 111 determines at least one of the one or more component modalities based, at least in part, on a viewpoint, contextual information, or a combination thereof associated with at least one viewer.

In step 504, the user attribution platform 111 causes, at least in part, a presentation of the one or more attribution indicators associated with the at least one of the one or more component modalities.

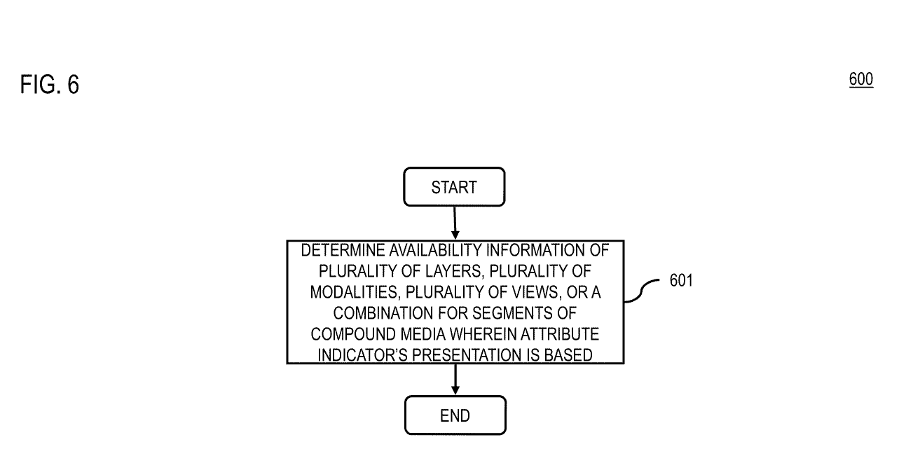

FIG. 6 is a flowchart of a process for providing attributions to the creators of the components of a compound media, according to one embodiment. In one embodiment, the user attribution platform 111 performs the process 600 and is implemented in, for instance, a chip set including a processor and a memory as shown in FIG. 13.

In step 601, the user attribution platform 111 determines availability information of at least one of the plurality of layers, the plurality of modalities, the plurality of views, or a combination thereof for one or more segments of the at least one compound media item, wherein the presentation of the one or more attribute indicators is based, at least in part, on the availability information. For instance, the visual attribution of one or more creators is related to one or more views available for the compound media. This implies that a single view at a given temporal instant may be attributed to one or more creators, and multiple views at a given temporal instant may be attributed to a single creator.

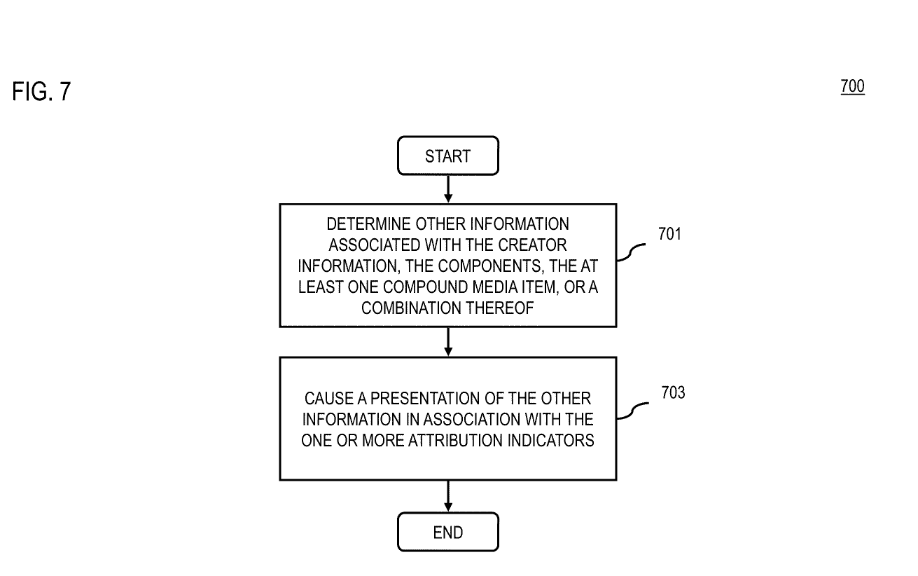

FIG. 7 is a flowchart of a process for providing attributions to the creators of the components of a compound media, according to one embodiment. In one embodiment, the user attribution platform 111 performs the process 700 and is implemented in, for instance, a chip set including a processor and a memory as shown in FIG. 13.

In step 701, the user attribution platform determines other information associated with the creator information and/or the components and./or a compound media item, causing, at least a presentation of the other information in association with the one or more attribution indicators. For instance, one or more advertisements can be added to a temporal segment of a compound media which is attributed specifically to (a) a spatial area of a view in case of a single view compound media; and/or (b) a spatial areas of one or more views of a multi-view compound media; and/or (c) different modalities of a compound media.

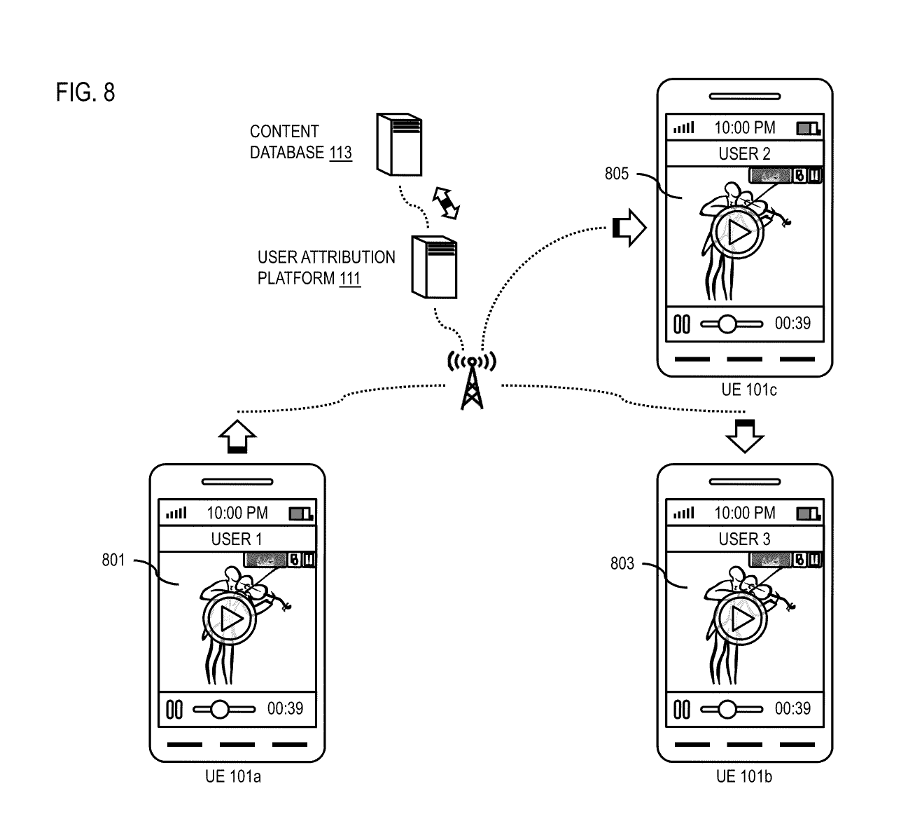

FIG. 8 is a diagram of user interfaces utilized in the processes of FIGS. 3-7, according to various embodiments. As illustrated, UE 101a, UE 101b and UE 101c have user interfaces 801, 803, and 805, respectively. Whenever a user records media and creates a compound media for publication, for example, UE 101a, the user attribution module 109 through its various components dynamically identifies the creator of various contents used in the composition of the compound media. The user attribution module 109 selects a rendering of a presentation attributing the creators based on the contextual information of the social media service that can be accessed by UE 101a, UE 101b, and UE 101c. By way of example, the user attribution platform 111 sends a request to each accessing UE 101 for device capabilities, and/or contextual information to determine the user interface elements. Upon receiving the required information, the user attribution platform 111 determines a presentation attributing the creators of the original contents, and then presents it with the compound media. For example, a user requests the creation of a 1 hour remix video created from a plurality of content. The user attribution platform 111 generates a method for viewing multi-user attribution in multi-view content. The visual attribution is done by overlaying the creators name/avatar and/or original source content URL at the corresponding time-offset from where the content was utilized in the creation of a compound media and/or linkage to the user's social network page, etc. Further, the user attribution platform 111 may enable a segment based on commenting, reporting, rating the content by clicking on the visual overlay. As an embodiment, all the user media may also consist of compound hyperlinks on segments that were used in one or more compound media, enabling a two way linkage between the contributor content and the compound media, for example, each time a compound media is viewed, the user attribution hyperlink also updates the user media usage account. As another embodiment, each time a user media is viewed, the compound media can increase priority for usage of that media automatically. Such two way mechanism can be used to perform accounting and consequently enable royalty distribution mechanism.

FIG. 9 is a diagram of user interfaces utilized in the processes of FIGS. 3-7, according to various embodiments. The figure displays the user attribution for compound social media. The technical implementation of the visual attribution of content creators when used in a compound media or a remix depends on the modalities of the compound media as well as other implementation characteristics (for example if the video is multi-view, multi-channel audio etc.). The visual attribution of content creator may be done embedding the information about the content creator for each segment of video that is included. This embedding can be performed at the time of the compound media creation. In different embodiments, the content creator visual attribution may be a separate file which may be streamed in parallel with the media. The visual attribution information for content creator also includes the different media types (audio, video, image, special effects etc.), share in each media type (e.g., single view, multiple view), creators name, social networks links, preferred attribution modality (for example shown as an overlay on top of the rendered video, aggregated acknowledgement in the beginning or end ordered by their order of appearance, etc.) and any other information that helps identify and promote the content creator. For example, the user interface 901 may currently be presenting a representation of a compound media file and/or a compound media segment. By way of example, the media segment may be a video. A user requests the creation of a remix video using 10 different sources in a video sharing media. The compound media file may have been previously processed by the user attribution platform 111 so as to generate a visual attribution by overlaying user interface. Indicators 903 may be user interface elements associated with creators name/avatar, it may be associated with a tactile modality where the user touches the indicators 903 to implement the various functionalities, for example, hyperlink to user's social network page, etc. Further, every time this user's segment is viewed, an HTTP post (or similar transport protocol) updates the user media view count. The user interface 901 may further include indicator 905 which may be a tactile modality user interface element that links to the original source content URL at the corresponding time-offset from where the content was utilized in the creation of a compound media. Further, the user interface 901 may include an elements 907 and 909 that enable a segment based on commenting, reporting, rating the content segment used in the compound media by clicking on the visual overlay. The user interface elements of the tactile, visual and audio modalities may have been associated with the compound media segment presented at the user interface 901 based on the functions and/or processes of the user attribution platform 111 described above.

As an embodiment, all the user media may also consist of compound hyperlinks on segments that were used in one or more compound media, enabling a two way linkage between the contributor content and the compound media, for example, each time a compound media is viewed, the user attribution hyperlink also updates the user media usage account. As another embodiment, each time a user media is viewed, the compound media can increase priority for usage of that media automatically. Such two way mechanism can be used to perform accounting and consequently enable royalty distribution mechanism.

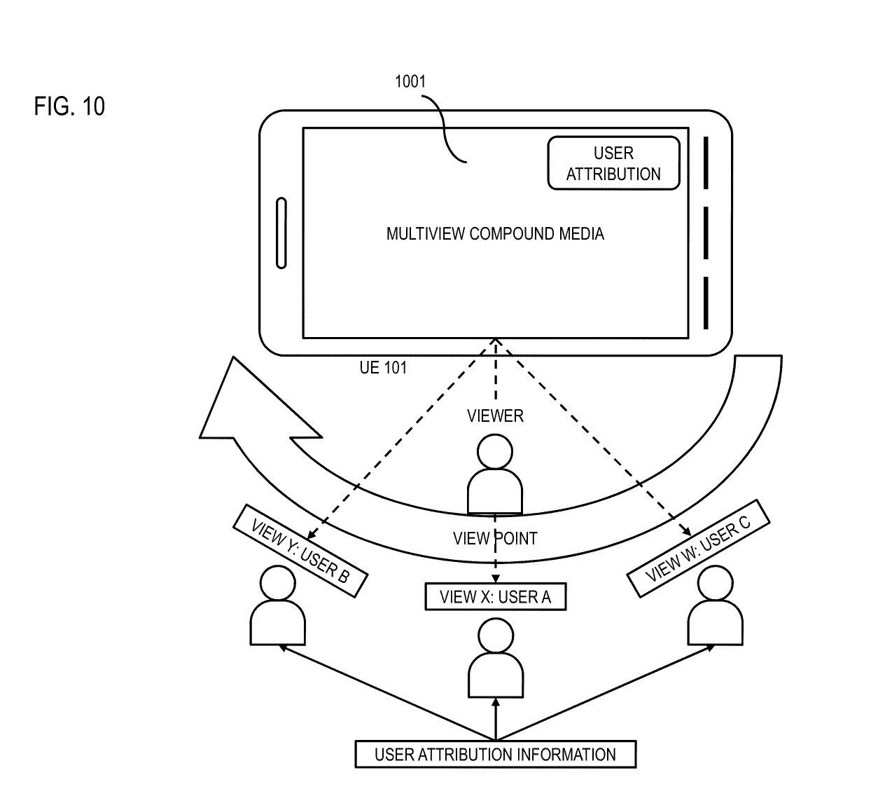

FIG. 10 is a diagram of user interfaces utilized in the processes of FIGS. 3-7, according to various embodiments. The figure illustrates a method for user attribution for multi view content where multiple views are generated using content from one or more users. Depending on the view point of the compound media viewer, the user would see a view of the multi view content and the user attribution corresponding to that view. This enables view level user attribution of content and also as an implementation embodiment to have multiple contributing users represented on different views of the same temporal segment. Following are the steps involved in generating the user attribution information and rendering it while consuming the multi view content.

Firstly, determine the contributed content from users that is used in generating the compound media. Then, determine the usage information of the contributed content in temporal interval as well as the one or more views for the given temporal interval. A given temporal interval can have one or more users' content for one or more views.

The user attribution metadata information consists of the following vector:

<TIME STAMP OR FRAME INDEX 1>
<View 1><User ID 1><User ID 2>.....<User ID N></View 1>
<View 2><User ID 1><User ID 2>.....<User ID N></View 2>
<View M><User ID 1><User ID 2>...... <User ID K></View M>
</TIME STAMP OR FRAME INDEX 1>
<TIME STAMP OR FRAME INDEX 2>
<View 1><User ID 1><User ID 2>.....<User ID N></View 1>
<View 2><User ID 1><User ID 2>.....<User ID N></View 2>
<View M><User ID 1><User ID 2>...... <User ID K></View M>
</TIME STAMP OR FRAME INDEX 2>.
.
.
.
<TIME STAMP OR FRAME INDEX N>
<View 1><User ID 1><User ID 2>.....<User ID N></View 1>
<View 2><User ID 1><User ID 2>.....<User ID N></View 2>
<View M><User ID 1><User ID 2>...... <User ID K></View M>
</TIME STAMP OR FRAME INDEX N>

This meta information may either be stored as a separate stream in the multi-view file container or it may be stored as a separate block which is read and interpreted by the video player. Another possibility is that this information is stored as a separate file and streamed in parallel with the video file. The video player overlays the user attribution information while rendering.

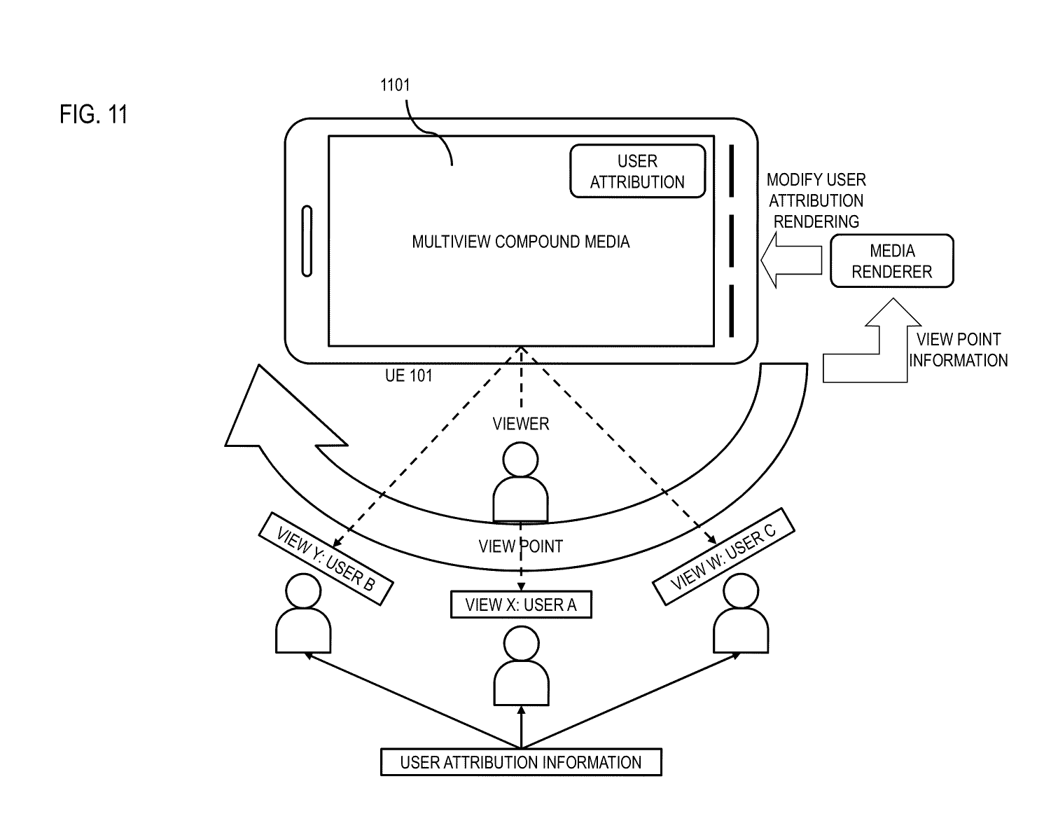

FIG. 11 is a diagram of user interfaces utilized in the processes of FIGS. 3-7, according to various embodiments. FIG. 10 illustrates a method for user attribution for multi-user attribution corresponding to multiple modalities for a given temporal interval. This requires a method for sensing view point of the viewer and also changes in the view point, which can be used by the media rendered to modify the user attribution information. For example, by default only the video modality contribution is displayed, if the viewer moves vertically or horizontally with regards to the display or rendering device, the user attribution is modified to render another media modality contributor. As in case of multi-view content user attribution information illustration above, the multimodal information can be similarly generated and formatted. The metadata information vector is extended to include the modality information in addition to the view or channel information:

<TIME STAMP or Frame Index X>
<Modality Video>
<View 1><User ID 1><User ID 2>.....<User ID N></View 1>
<View 2><User ID 1><User ID 2>.....<User ID N>......<View M>
<User ID 1><User ID 2>...... <User ID K></View 2>
</Modality Video>
<Modality Audio>
<Channel 1><User ID 1><User ID 2>.....<User ID N></Channel 1>
<Channel 2><User ID 1><User ID 2>.....<User ID N></Channel 2>
<Channel M><User ID 1><User ID 2>...... <User ID K></Channel M>
</Modality Audio>
</TIME SEGMENT X>

Based on the number of modalities, the media player application can decide which modality's user attribution information changes based on what movements. In other embodiments, the meta information itself contains the user interaction bindings for each modality. For example, the user attribution information can define Modality 1 for “Horizontal movement of the viewer viewpoint”, Modality 2 for “Vertical movement of the viewer viewpoint”, etc.

<TIME STAMP or Frame Index X>
<Modality Video>
<Modality Activation> Horizontal viewpoint shift </Modality Activation>
<View 1><User ID 1><User ID 2>.....<User ID N></View 1>
<View 2><User ID 1><User ID 2>.....<User ID N>......<View M>
<User ID 1><User ID 2>...... <User ID K></View 2>
</Modality Video>
<Modality Audio>
<Modality Activation> Vertical viewpoint shift </Modality Activation>
<Channel 1><User ID 1><User ID 2>.....<User ID N></Channel 1>
<Channel 2><User ID 1><User ID 2>.....<User ID N></Channel 2>
<Channel M><User ID 1><User ID 2>...... <User ID K></Channel M>
</Modality Audio>
</TIME SEGMENT X>

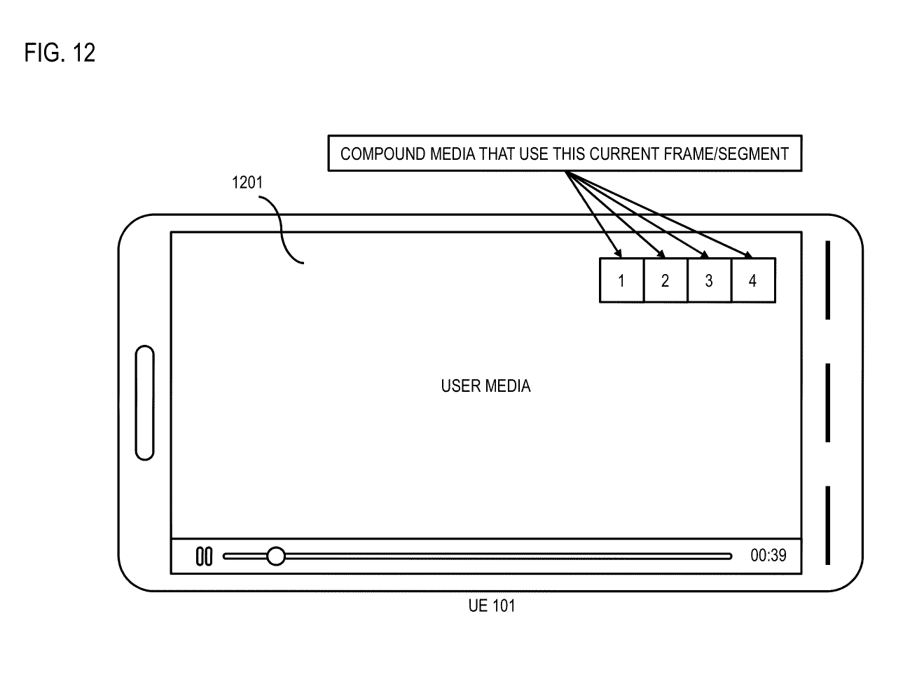

FIG. 12 is a diagram of user interfaces utilized in the processes of FIGS. 3-7, according to various embodiments. The figure relates to a concept of two way linkages between the contributed media or source media and the compound media respectively. Each time a segment of compound media is rendered, an update is executed via the user attribution overlay to update the view count of the user media. Also, each user media is linked via a composite hyperlink for one or more compound media that have used the given temporal segment. Multiple views/modalities/layers of the user media are overlaid with corresponding compound media hyperlinks. The contributed media use in compound media is also indicated and viewed in the same manner as in case of user attribution overlay. Therefore, each time a compound media is viewed, the user attribution hyperlink also updates the user media usage account. As another embodiment, each time a user media is viewed, the compound media can increase priority for usage of that media automatically. This two way linkage can be used to perform accounting and consequently enable royalty distribution mechanism, having a business enabler aspect, as well.

The processes described herein for providing attributions to the creators of the components of a compound media may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 13 illustrates a computer system 1300 upon which an embodiment of the invention may be implemented. Although computer system 1300 is depicted with respect to a particular device or equipment, it is contemplated that other devices or equipment (e.g., network elements, servers, etc.) within FIG. 13 can deploy the illustrated hardware and components of system 1300. Computer system 1300 is programmed (e.g., via computer program code or instructions) to provide attributions to the creators of the components of a compound media as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of providing attributions to the creators of the components of a compound media.

A bus 1310 includes one or more parallel conductors of information so that information is transferred quickly among devices coupled to the bus 1310. One or more processors 1302 for processing information are coupled with the bus 1310.

A processor (or multiple processors) 1302 performs a set of operations on information as specified by computer program code related to providing attributions to the creators of the components of a compound media. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1300 also includes a memory 1304 coupled to bus 1310. The memory 1304, such as a random access memory (RAM) or any other dynamic storage device, stores information including processor instructions for providing attributions to the creators of the components of a compound media. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or any other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for providing attributions to the creators of the components of a compound media, is provided to the bus 1310 for use by the processor from an external input device 1312, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT), a liquid crystal display (LCD), a light emitting diode (LED) display, an organic LED (OLED) display, a plasma screen, or a printer for presenting text or images, and a pointing device 1316, such as a mouse, a trackball, cursor direction keys, or a motion sensor, for controlling a position of a small cursor image presented on the display 1314 and issuing commands associated with graphical elements presented on the display 1314, and one or more camera sensors 1394 for capturing, recording and causing to store one or more still and/or moving images (e.g., videos, movies, etc.) which also may comprise audio recordings. In some embodiments, for example, in embodiments in which the computer system 1300 performs all functions automatically without human input, one or more of external input device 1312, display device 1314 and pointing device 1316 may be omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of ASICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 105 for providing attributions to the creators of the components of a compound media to the UE 101.

The term “computer-readable medium” as used herein refers to any medium that participates in providing information to processor 1302, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1308. Volatile media include, for example, dynamic memory 1304. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1320.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system 1300 can be deployed in various configurations within other computer systems, e.g., host 1382 and server 1392.

At least some embodiments of the invention are related to the use of computer system 1300 for implementing some or all of the techniques described herein. According to one embodiment of the invention, those techniques are performed by computer system 1300 in response to processor 1302 executing one or more sequences of one or more processor instructions contained in memory 1304. Such instructions, also called computer instructions, software and program code, may be read into memory 1304 from another computer-readable medium such as storage device 1308 or network link 1378. Execution of the sequences of instructions contained in memory 1304 causes processor 1302 to perform one or more of the method steps described herein. In alternative embodiments, hardware, such as ASIC 1320, may be used in place of or in combination with software to implement the invention. Thus, embodiments of the invention are not limited to any specific combination of hardware and software, unless otherwise explicitly stated herein.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server host 1392 transmits program code for a particular application, requested by a message sent from computer 1300, through Internet 1390, ISP equipment 1384, local network 1380 and communications interface 1370. The received code may be executed by processor 1302 as it is received, or may be stored in memory 1304 or in storage device 1308 or any other non-volatile storage for later execution, or both. In this manner, computer system 1300 may obtain application program code in the form of signals on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

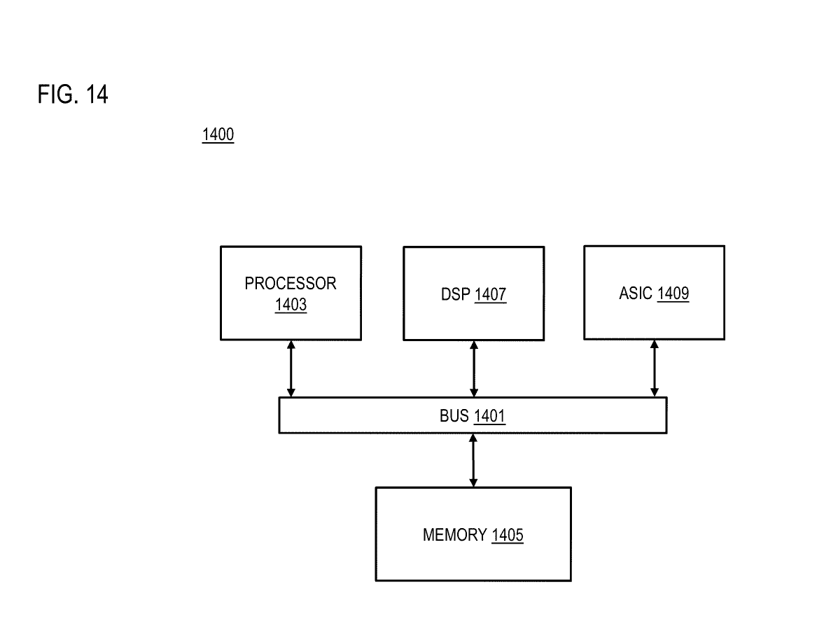

FIG. 14 illustrates a chip set or chip 1400 upon which an embodiment of the invention may be implemented. Chip set 1400 is programmed to provide attributions to the creators of the components of a compound media as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1400 can be implemented in a single chip. It is further contemplated that in certain embodiments the chip set or chip 1400 can be implemented as a single “system on a chip.” It is further contemplated that in certain embodiments a separate ASIC would not be used, for example, and that all relevant functions as disclosed herein would be performed by a processor or processors. Chip set or chip 1400, or a portion thereof, constitutes a means for performing one or more steps of providing user interface navigation information associated with the availability of functions. Chip set or chip 1400, or a portion thereof, constitutes a means for performing one or more steps of providing attributions to the creators of the components of a compound media.

In one embodiment, the chip set or chip 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1400 includes merely one or more processors and some software and/or firmware supporting and/or relating to and/or for the one or more processors.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to provide attributions to the creators of the components of a compound media. The memory 1405 also stores the data associated with or generated by the execution of the inventive steps.

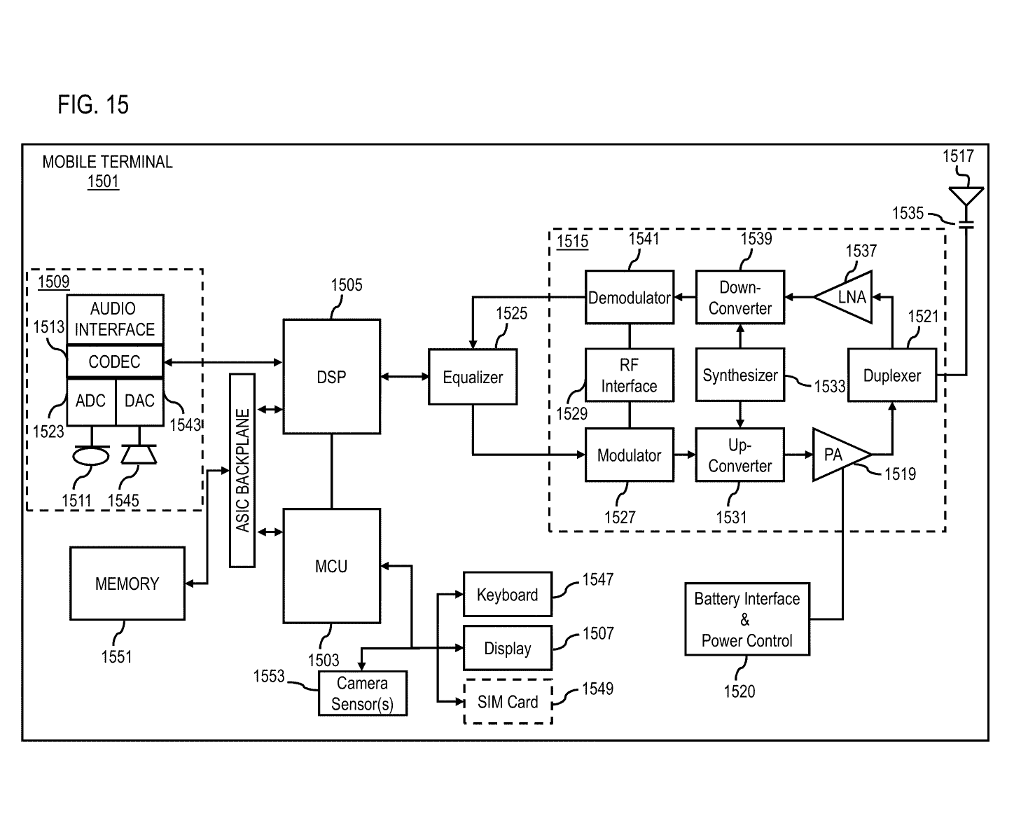

FIG. 15 is a diagram of exemplary components of a mobile terminal (e.g., handset) for communications, which is capable of operating in the system of FIG. 1, according to one embodiment. In some embodiments, mobile terminal 1501, or a portion thereof, constitutes a means for performing one or more steps of providing attributions to the creators of the components of a compound media. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile terminal functions that perform or support the steps of providing attributions to the creators of the components of a compound media. The display 1507 includes display circuitry configured to display at least a portion of a user interface of the mobile terminal (e.g., mobile telephone). Additionally, the display 1507 and display circuitry are configured to facilitate user control of at least some functions of the mobile terminal. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile terminal 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503 which can be implemented as a Central Processing Unit (CPU).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile terminal 1501 to provide attributions to the creators of the components of a compound media. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the terminal. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile terminal 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable storage medium known in the art. The memory device 1551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1549 carries, for instance, important information, such as the cellular phone number, the carrier supplying service, subscription details, and security information. The SIM card 1549 serves primarily to identify the mobile terminal 1501 on a radio network. The card 1549 also contains a memory for storing a personal telephone number registry, text messages, and user specific mobile terminal settings.

Further, one or more camera sensors 1553 may be incorporated onto the mobile station 1501 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more creator information for one or more components of at least one compound media item; and
a presentation of one or more attribution indicators to associate the creator information with the one or more components at least substantially concurrently with a presentation of the at least one compound media item.

2. A method of claim 1, wherein the one or more attribution indicators includes, at least in part, one or more multi-functional indicators.

3. A method of claim 2, wherein one or more functions of the one or more multi-functional indicators include, at least in part, (a) presenting additional information associated with one or more creators of the one or more components; (b) linking to source media associated with the one or more components; (c) providing historical creator information; (d) updating usage information for the one or more components, the at least one compound media item; or (e) a combination thereof.

4. A method of claim 1, wherein the (1) data and/or (2) information and/or (3) at least one signal are further based, at least in part, on the following:
at least one determination of one or more temporal intervals for the presentation of the one or more attribution indicators based, at least in part, on the occurrence of the one or more components in the presentation of the at least one compound media item.

5. A method of claim 1, wherein the at least one compound media item includes, at least in part, a plurality of layers, a plurality of modalities, a plurality of views, or a combination thereof.

6. A method of claim 5, wherein the (1) data and/or (2) information and/or (3) at least one signal are further based, at least in part, on the following:
a categorization of the creator information based, at least in part, on one or more component modalities associated with the one or more components; and
an association of the one or more component modalities with respective one or more of the plurality of layers, the plurality of modalities, the plurality of views, or a combination thereof,
wherein the presentation of the one or more attribution indicators is based, at least in part, on the association.

7. A method of claim 6, wherein the (1) data and/or (2) information and/or (3) at least one signal are further based, at least in part, on the following:
at least one determination of one of the one or more component modalities based, at least in part, on a viewpoint, contextual information, or a combination thereof associated with at least one viewer; and
a presentation of the one or more attribution indicators associated with the at least one of the one or more component modalities.

8. A method of claim 5, wherein the (1) data and/or (2) information and/or (3) at least one signal are further based, at least in part, on the following:
at least one determination of one or more availability information of at least one of the plurality of layers, the plurality of modalities, the plurality of views, or a combination thereof for one or more segments of the at least one compound media item,
wherein the presentation of the one or more attribute indicators is based, at least in part, on the availability information.

9. A method of claim 6, wherein the (1) data and/or (2) information and/or (3) at least one signal are further based, at least in part, on the following:
at least one determination of other information associated with the creator information, the one or more components, the at least one compound media item, or a combination thereof; and
a presentation of the other information in association with the one or more attribution indicators.

10. A method comprising facilitating a processing of and/or processing (1) data and/or (2) information and/or (3) at least one signal, the (1) data and/or (2) information and/or (3) at least one signal based, at least in part, on the following:
a receipt of a compound media item from a server, wherein creator information for one or more components of at least one compound media item has been determined; and
a presentation of one or more attributes indicators to associate the creator information with the one or more components at least substantially concurrently with a presentation of the at least one compound media item.

11. An apparatus comprising:
at least one processor; and
at least one memory including computer program code for one or more programs,
the at least one memory and the computer program code configured to, with the at least one processor, cause the apparatus to perform at least the following,
determine creator information for one or more components of at least one compound media item; and
cause, at least in part, a presentation of one or more attribution indicators to associate the creator information with the one or more components at least substantially concurrently with a presentation of the at least one compound media item.

12. An apparatus of claim 11, wherein the one or more attribution indicators includes, at least in part, one or more multi-functional indicators.

13. An apparatus of claim 12, wherein one or more functions of the one or more multi-functional indicators include, at least in part, (a) presenting additional information associated with one or more creators of the one or more components; (b) linking to source media associated with the one or more components; (c) providing historical creator information; (d) updating usage information for the one or more components, the at least one compound media item; or (e) a combination thereof.

14. An apparatus of claim 11, wherein the apparatus is further caused to:
determine one or more temporal intervals for the presentation of the one or more attribution indicators based, at least in part, on the occurrence of the one or more components in the presentation of the at least one compound media item.

15. An apparatus of claim 11, wherein the at least one compound media item includes, at least in part, a plurality of layers, a plurality of modalities, a plurality of views, or a combination thereof.

16. An apparatus of claim 15, wherein the apparatus is further caused to:
cause, at least in part, a categorization of the creator information based, at least in part, on one or more component modalities associated with the one or more components; and
cause, at least in part, an association of the one or more component modalities with respective one or more of the plurality of layers, the plurality of modalities, the plurality of views, or a combination thereof,
wherein the presentation of the one or more attribution indicators is based, at least in part, on the association.

17. An apparatus of claim 16, wherein the apparatus is further caused to:
determine at least one of the one or more component modalities based, at least in part, on a viewpoint, contextual information, or a combination thereof associated with at least one viewer; and
cause, at least in part, a presentation of the one or more attribution indicators associated with the at least one of the one or more component modalities.

18. An apparatus of claim 15, wherein the apparatus is further caused to:
determine availability information of at least one of the plurality of layers, the plurality of modalities, the plurality of views, or a combination thereof for one or more segments of the at least one compound media item,
wherein the presentation of the one or more attribute indicators is based, at least in part, on the availability information.

19. An apparatus of claim 16, wherein the apparatus is further caused to:
determine other information associated with the creator information, the one or more components, the at least one compound media item, or a combination thereof; and
cause, at least in part, a presentation of the other information in association with the one or more attribution indicators.

20. An apparatus comprising:
at least one processor; and
at least one memory including computer program code for one or more programs,
the at least one memory and the computer program code configured to, with the at least one processor, cause the apparatus to perform at least the following,
receive a compound media item from a server, wherein creator information for one or more components of at least one compound media item has been determined; and
cause, at least in part, a presentation of one or more attributes indicators to associate the creator information with the one or more components at least substantially concurrently with a presentation of the at least one compound media item.

21.-50. (canceled)
